(19) United States
(12) Patent Application Publication
(10) Pub. No.: US 2014/0210857 A1
(43) Pub. Date: Jul. 31, 2014

(54) REALIZATION METHOD AND DEVICE FOR TWO-DIMENSIONAL CODE AUGMENTED REALITY

(71) Applicant: Tencent Technology (Shenzhen) Company Limited, Shenzhen (CN)

(72) Inventors: Xiao LIU, Shenzhen (CN); Hailong LIU, Shenzhen (CN); Bo CHEN, Shenzhen (CN)

(73) Assignee: Tencent Technology (Shenzhen) Company Limited, Shenzhen (CN)

(21) Appl. No.: 14/108,214

(22) Filed: Dec. 16, 2013

Related U.S. Application Data
(63) Continuation of application No. PCT/CN2013/085928, filed on Oct. 25, 2013.

(30) Foreign Application Priority Data
Jan. 28, 2013 (CN) 201310031075.1

(51) Int. Cl. G06T 19/00

(52) U.S. Cl. CPC G06T 19/006
USPC 345/633

(57) ABSTRACT

A computer-implemented method for two-dimensional code augmented reality includes: detecting an image capture of a two-dimensional code through a camera video frame; identifying the contour of the two-dimensional code captured in the camera video frame; decoding the information embedded in the detected two-dimensional code; obtaining content information corresponding to the decoded two-dimensional code; tracking the identified contour of the two-dimensional code within the camera video frame to obtain the position information of the two-dimensional code in the camera video frame; performing augmented reality processing on the two-dimensional code based on the content information and the position information; and generating the augmented reality on the device while simultaneously displaying real-world imagery on the display of the device, wherein any visual augmented reality is displayed in accordance with the location of the two-dimensional code in the video frame.

### RELATED APPLICATIONS

This application is a continuation application of PCT Patent Application No. PCT/CN2013/085928, entitled “REALIZATION METHOD AND DEVICE FOR TWO-DIMENSIONAL CODE AUGMENTED REALITY” filed Oct. 25, 2013, which claims priority to Chinese Patent Application No. 201310031075.1, “REALIZATION METHOD AND DEVICE FOR TWO-DIMENSIONAL CODE AUGMENTED REALITY,” filed Jan. 28, 2013, both of which is hereby incorporated by reference in their entirety.

### FIELD OF THE INVENTION

The present application relates to the technical field of two-dimensional codes, particularly to a realization method and device of two-dimensional code augmented reality.

### BACKGROUND OF THE INVENTION

Along with social progress and the information technology era, more and more people depend on a variety of consumer electronic devices (like mobile terminal, personal digital assistant (PDA), etc.) to obtain a variety of information. For example, to make a phone call, to communicate with others, to browse the web, to get news and to check email. This human-computer interaction is accomplished through a broad range of implementations, including conventional hardware equipment like a keyboard, mouse, etc. and more recently, equipment such as touch screens.

However, people are not completely satisfied with the existing human-computer interaction options, and they expect a new generation of human-computer interaction that can be as natural, accurate and prompt as human-human interaction. Therefore in the 1990's, research on human-computer interaction embarked on a multi-modal (providing more than one mode of interaction) phase, known as Human-Computer Nature Interaction (HCNI) or Human-Machine Nature Interaction (HMNI).

Virtual reality (VR) technology is a three-dimensional virtual world generated by using computer simulation. It provides users with visual, auditory and/or haptical sensory simulation to make the users feel as if they are actually observing the virtual elements in three dimensional space and able to interact with the elements in the virtual world as well. Virtual reality (VR) technology has the capability to create virtual simulations beyond the realm of reality. It is an evolving computer technology developed with multimedia technology, which utilizes three-dimensional graphics, multi-sensor interactions and high-resolution displays to generate three-dimensional lifelike virtual environments.

Augmented Reality (AR) is a new technology development in the field of virtual reality, and also known as mixed reality. AR is used to increase the perception of users interacting in the real world, through information provided by a computer system. AR applies virtual reality information into the real world and superimposes the virtual subject, scene or information generated by the computer into the particular real world scenario so as to realize the augmented reality enhancement.

With the popularity of two-dimensional code technology in recent years, some augmented reality methods have been developed utilizing two-dimensional codes. Currently, the existing two-dimensional code augmented reality methodology is mainly based on the open-source two-dimensional code recognition library. Its advantage is that it is simple to realize and well-positioned, but the disadvantage is that the speed is very slow when the two-dimensional code detection and recognition algorithm are mixed together. Furthermore, in the existing methodology, there is no tracking method for the two-dimensional code, every frame is required for detection and recognition, the success rate of detection is very low and it can't achieve the real-time requirement of detection by a mobile terminal.

### SUMMARY

The above deficiencies and other problems associated with the conventional approach of generating augmented reality are reduced or eliminated by the invention disclosed below. In some embodiments, the invention is implemented in a computer system that has one or more processors, memory and one or more modules, programs or sets of instructions stored in the memory for performing multiple functions. Instructions for performing these functions may be included in a computer program product configured for execution by one or more processors.

One aspect of the invention involves a computer-implemented method performed by a computer having one or more processors and memory. The computer-implemented method includes: detecting an image capture of a two-dimensional code through a camera video frame; identifying the contour of the two-dimensional code captured in the camera video frame; decoding the information embedded in the detected two-dimensional code; obtaining content information corresponding to the decoded two-dimensional code; tracking the identified contour of the two-dimensional code within the camera video frame to obtain the position information of the two-dimensional code in the camera video frame; performing augmented reality processing on the two-dimensional code based on the content information and the position information; and generating the augmented reality on the device while simultaneously displaying real-world imagery on the display of the device, wherein any visual augmented reality is displayed in accordance with the location of the two-dimensional code in the video frame.

Another aspect of the invention involves a computer system. The computer system includes memory, one or more processors, and one or more programs stored in the memory and configured for execution by the one or more processors. The one or more programs include: detecting an image capture of a two-dimensional code through a camera video frame; identifying the contour of the two-dimensional code captured in the camera video frame; decoding the information embedded in the detected two-dimensional code; obtaining content information corresponding to the decoded two-dimensional code; tracking the identified contour of the two-dimensional code within the camera video frame to obtain the position information of the two-dimensional code in the camera video frame; performing augmented reality processing on the two-dimensional code based on the content information and the position information; and generating the augmented reality on the device while simultaneously displaying real-world imagery on the display of the device, wherein any visual augmented reality is displayed in accordance with the location of the two-dimensional code in the video frame.

Another aspect of the invention involves a non-transitory computer readable storage medium storing one or more programs, the one or more programs comprising instructions, which when executed by an electronic device with a display and a camera, cause the device to: detect an image capture of a two-dimensional code through a camera video frame; identify the contour of the two-dimensional code captured in the camera video frame; decode the information embedded in the detected two-dimensional code; obtain content information corresponding to the decoded two-dimensional code; track the identified contour of the two-dimensional code within the camera video frame to obtain the position information of the two-dimensional code in the camera video frame; perform augmented reality processing on the two-dimensional code based on the content information and the position information; and generate the augmented reality on the device while simultaneously displaying real-world imagery on the display of the device, wherein any visual augmented reality is displayed in accordance with the location of the two-dimensional code in the video frame.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flowchart diagram of a realization method of two-dimensional code augmented reality based on an embodiment of the present application.

FIG. 2 is a demonstrative flowchart diagram of a realization method of two-dimensional code augmented reality based on an embodiment of the present application.

FIG. 3 is a schematic diagram of a QR two-dimensional code anchor point based on an embodiment of the present application.

FIG. 4 is a characteristic schematic diagram of a QR two-dimensional code anchor point based on an embodiment of the present application.

FIG. 5 is a flowchart diagram of a two-dimensional code detection method based on an embodiment of this invention.

FIG. 6 is a diagram illustrative of an exemplary scan of horizontal characteristics and scan of vertical characteristics of a QR two-dimensional code based on an embodiment of the present application.

FIG. 7 is a flowchart diagram of a two-dimensional code detection and tracking method based on an embodiment of this invention.

FIG. 8 is a demonstrative flowchart diagram of a two-dimensional code tracking method based on an embodiment of this invention.

FIG. 9 is a structural diagram of a realization apparatus of two-dimensional code augmented reality based on an embodiment of the present application.

FIG. 10 is an exemplary representation of an embodiment of the present application demonstrating detection of a two-dimensional code and display of corresponding augmented reality information.

FIG. 11 is a diagram of a client-server environment for augmented reality generation, in accordance with some implementations.

FIG. 12 is a diagram of an example implementation of the device for augmented reality generation, in accordance with some implementations.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

In order to make a clearer understanding of purpose, technical scheme and advantages of this invention, the present application is described in detail below in combination with the attached drawings.

In conventional technology, augmented reality is currently implemented in two main schemes, namely generating augmented reality in response to detection of a special sign or symbol, and generating augmented reality in response to detection of real-life objects.

The augmented reality method used for the special signs already has the technology of using the self-defined black-white identification code for positioning, for example, BCH code, concentric circles signs, etc. used by ARToolKit augmented reality open-source library developed by HIT laboratory of University of Washington are commonly used. The identification code of such kind of scheme is simple, the detecting algorithm is simple, speed of operation of client-side is quicker, and the recognition algorithm usually can be put into the client-side, as it needs for no support of a lot of characteristic library. However, the disadvantage of such kind of scheme is that usually the identification code itself is relatively fixed and simple, the amount of information is less, meanwhile the format of identification code is not universal so as to difficultly popularize. For instance, in the existing technology, for the augmented reality algorithm of specific signs BCH code like, etc. (such as BCH code used by ARToolKit), totally 4096 numbers from 0-4095 can be expressed, it can't express more digital content and a richer information like text, etc., and less amount of information is expressed by more self-defined specific signs.

In the existing technology, the very popular augmented reality method in the recent years is the augmented reality method used for the natural pictures. This method won't adopt the specific sign and only need to take the natural plan pictures as the signs to position. Such method usually adopts the way of key points detection (such as SIFT, SURF, FAST, etc. key points detection algorithm) and local characteristic descriptor (such as SIFT, SURF, BRIEF, etc. local characteristic descriptor). For the suited characteristic points, at last it also needs to adopt the geometric verification (such as RANSAC, PROSAC, etc.) geometric verification algorithm to get its homography matrix. So its front end detection algorithm is very complex and difficult to achieve the real-time. Meanwhile, more importantly than all of that, its recognition needs to train the characteristic data library off line, the run time of training and recognition algorithm is very long, meanwhile, for a huge amount of pictures, it must set up a database at server-side, therefore the recognition algorithm can't be put into the client-side so that the multi-objective augmented reality method can't be realized.

As the technology of two-dimensional code becomes increasingly popular, some augmented reality methods applied in the two-dimensional code have been developed in recent years. Currently, the existing two-dimensional code augmented reality method is based on the open-source two-dimensional code recognition library such as ZBar, ZXing, its advantage is simple to realize and well-positioned, but the disadvantage is that on the one hand, the speed is very slow when the detection and recognition algorithm are mixed together; on the other hand, there is no tracking method, every frame is required for detection and recognition, the success rate of detection is very low and at the same time it can't achieve the real-time requirement of various mobile equipments.

The arithmetic speed of conventional QR two-dimensional code recognition algorithm is relatively slow and can't meet the real-time requirement of detection by various mobile equipments. Specifically, the conventional QR two-dimensional code recognition algorithm (such as ZBar, ZXing, etc.) can reach the speed of near real-time on the PC, however, only 1-2 frames per second can be handled on the mobile equipments, which can't meet the real-time requirement (25 frames per second), so applying the conventional QR two-dimensional code recognition library for augmented reality technology can't realize the effects of real-time positioning and real-time display. This is mainly caused by two reasons: one is that the conventional QR two-dimensional code recognition algorithm is coupled with the detection module, but the bottle neck is mainly in the part of recognition; the other is that the conventional QR two-dimensional code recognition algorithm doesn't have the tracking module of QR two-dimensional code, so it can't realize to real-time track the position of QR two-dimensional code.

For these aforementioned existing technical defects, the embodiment of the present application proposes a realization method of two-dimensional code augmented reality.

Firstly, it explains the relevant words that might appear in the corresponding description of the embodiment of the present application. Camera video frame image: it specifically refers to the image data obtained from each frame of the video obtained from camera; initial camera grayscale frame: it specifically refers to the grayscale image obtained after the grayscale transformation of the first camera video frame image when the tracking starts; current camera grayscale frame: it specifically refers to the grayscale image obtained after the grayscale transformation of the current camera video frame image; the previous camera grayscale frame: it specifically refers to the grayscale image obtained after the grayscale transformation of the previous camera video frame image; display video frame image: it specifically refers to the image data obtained from each frame of display video taken as the display material superposing to the imaging video frame image; original two-dimensional code image: it specifically refers to the original two-dimension code direct picture without any changes; camera two-dimensional code image: it specifically refers to the two-dimensional code image part contained in the imaging video frame image obtained from the camera.

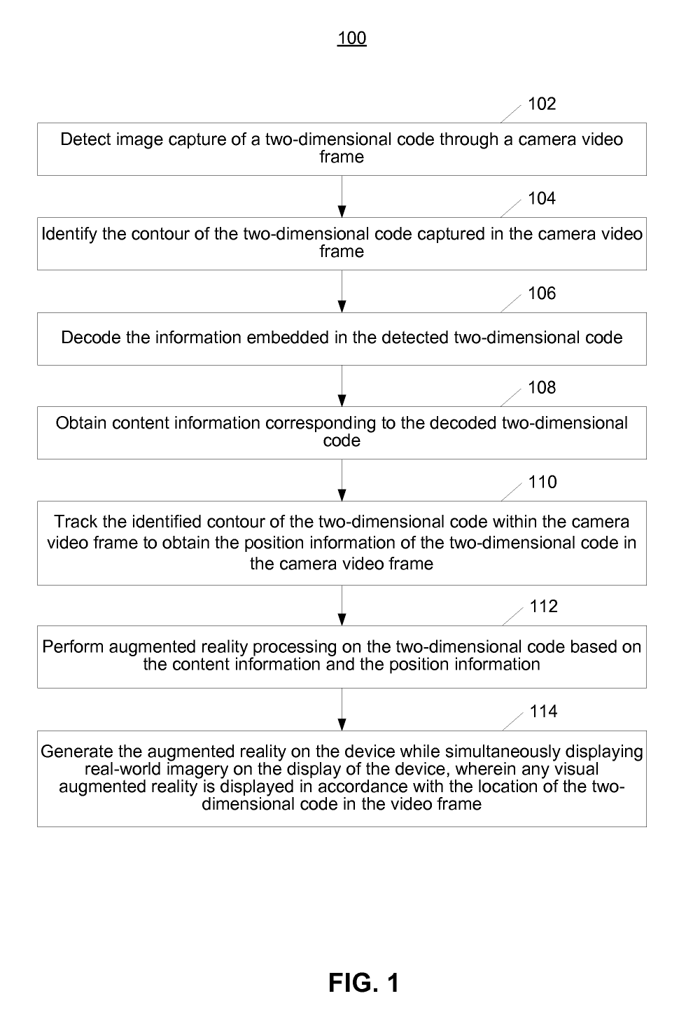

FIG. 1 is a flowchart diagram of a realization method 100 of two-dimensional code augmented reality based on an embodiment of the present application.

As is shown in FIG. 1, the method comprises detecting 102 image capture of a two-dimensional code through a camera video frame. Here, the camera video frame image is the image data obtained from each frame of video obtained from the camera. In some embodiments, the two-dimensional code is specifically a quick-response (QR) two-dimensional code. For example, a user may position an electronic device comprising a display screen and a camera over something displaying a two-dimensional code (e.g., a magazine advertisement with a QR code), such that the QR code is visually captured in the frame of the camera, and may also be displayed on the display screen.

The method 100 further includes identifying 104 the contour of the two-dimensional code captured in the camera video frame. The contour refers to the characteristics of the edges or border regions of the two-dimensional code. For example, identifying the contour of a QR code captured in the camera video frame includes identifying the positioning and alignment corners of the QR code. The element of identifying 104 the contour of the two-dimensional code is further described and elaborated upon in the present application.

The method 100 further includes decoding 106 the information embedded in the detected two-dimensional code, and obtaining 108 content information corresponding to the decoded two-dimensional code. For example, in some embodiments, the content information is video, audio, textual or graphical information or a combination of any of these or other types of content information. In some embodiments, the content information corresponding to the decoded two-dimensional code arrives from an augmented reality generation server.

The method 100 further includes tracking 110 the identified contour of the two-dimensional code within the camera video frame to obtain the position information of the two-dimensional code in the camera video frame. For example, a user may be capturing a QR code with a handheld electronic device, where the QR code is a part of a printed advertisement. As the user moves the device around, tracking the identified contour involves tracking the movement of the identified contour in the camera video frame, along with obtaining or determining the relative position of the two-dimensional code.

The method 100 further includes performing 112 augmented reality processing on the two-dimensional code based on the content information and the position information. For example, the content information may contain instructions for displaying a video on the display screen of an electronic device, and performing augmented reality processing comprising determining where to display the video on the screen relative to the position of the identified two-dimensional code. Finally, the method includes generating 114 the augmented reality on the device while simultaneously displaying real-world imagery on the display of the device, where any visual augmented reality is displayed in accordance with the location of the two-dimensional code in the video frame. In some embodiments, generating the augmented reality comprises displaying the augmented reality on the display of an electronic device. In some embodiments, the augmented reality based on the content information is displayed in the space occupied by the two-dimensional code. In some embodiments, this can include: converting the size of displaying content information (e.g., video image) into the size of original two-dimensional code image; conducting transformation for the content information (e.g., display video frame image) according to the position information of two-dimensional code in camera video frame image, and overlaying the transformed content information (e.g., display video frame image) in camera video frame image. In some embodiments, generating 114 the augmented reality on the device where any visual augmented reality is displayed in accordance with the location of the two-dimensional code in the video frame, involves moving the visual augmented reality in the display, to correspond to any detected movement of the two-dimensional code in the camera video frame (e.g., if the two-dimensional code is in the lower right corner of the camera video frame, the visual augmented reality is also generally in the lower right corner of the camera video frame).

Optionally, a three-dimensional 3D model can be displayed in the position of two-dimensional code based on the content information of mentioned two-dimensional code and position information of two-dimensional code in camera video frame image. Among which, displaying 3D model in the position of two-dimensional code can include: calculating transformation matrix of world coordinate of 3D model to plane coordinate of projection screen; using the transformation matrix to overlay the 3D model in camera video frame image according to the position information of two-dimensional code in camera video frame image.

In some embodiments, detecting 102 the two-dimensional code in the camera video frame image so as to obtain the contour of two-dimensional code mentioned can include: to transform this camera video frame image into the grayscale image, and transform the mentioned grayscale image into binary image; to execute the horizontal anchor point characteristic scanning and vertical anchor point characteristic scanning against this binary image so as to obtain the horizontal anchor point characteristic line and vertical anchor point characteristic line; to calculate the intersection point between the horizontal anchor point characteristic line and vertical anchor point characteristic line so as to obtain the position of anchor point of QR two-dimensional code; to obtain the contour of this QR two-dimensional code according to the calculated position of anchor point of QR two-dimensional code.

In some embodiments, this method can further include: when no two-dimensional code is detected in the camera video frame image, performing down sampling treatment against this camera video frame image, and reattempting to detect the two-dimensional code in the camera video frame image after performing the down sampling treatment.

In some embodiments, in accordance with a determination that no two-dimensional code is detected in the camera video frame (e.g., if the user moves the device away from the object with the two-dimensional code so that the code is no longer in the camera video frame), the method further includes terminating the presentation of the augmented reality on the device.

In some embodiments, the user can choose to terminate the presentation of augmented reality. For example, by pressing a physical button on the device (e.g., home or power button), by tapping a touch-screen display, by pressing a button on a touch-screen display or pressing a key on a keyboard. In some embodiments, the user can choose to mute any audible portion of the augmented reality presentation, through a visually conveyed affordance (e.g., a mute button shown on the device display). In some embodiments, the user can choose to pause, fast forward or rewind any presentation of augmented reality on the device. In some embodiments, the user can choose the format of augmented reality presentation (e.g., only audio, only video, only 2D video, only text etc.). In some embodiments, the device stores the augmented reality presentation preferences of the user, based on entered preferences, or learned preferences based on past behavior of the user (e.g., user typically choosing audio-only augmented reality). In some embodiments, the device prompts the user with an option of whether or not to allow the device to present the augmented reality (e.g., the device displays a prompt on the display asking the user to allow or disallow the presentation of augmented reality), and in accordance with a determination that the user allows the device to present the augmented reality, the device presents the augmented reality. In some embodiments, the augmented reality presentation has a visual component (e.g., video, image or text displayed on the device), and the visual component can be resized by the user (e.g., a video can be enlarged or made smaller). In some embodiments, visually presenting augmented reality is displayed as partially transparent or translucent, in order to facilitate the simultaneous display of real-world imagery.

In some embodiments, the augmented reality is presented to the user in real-time, as the content information corresponding to the augmented reality is downloaded from an augmented reality generation server. In some embodiments, the device downloads at least a portion of the augmented reality content information before presenting the augmented reality to the user (e.g., buffering the content if signal strength is low).

In some embodiments, the device can detect more than one two-dimensional code in the camera video frame and can simultaneously generate augmented reality corresponding to each detected two-dimensional code. For example, if a user detected 10 QR codes on a menu in a restaurant, each associated with an item on the menu, in an exemplary implementation, the device may present on the screen a translation of each menu item with an associated QR code.

In some embodiments, the two-dimensional code is specifically a quick-response (QR) two-dimensional code. In some embodiments, identifying 104 the contour of the two-dimensional code captured in the camera video frame further includes: according to the contour of two-dimensional code to obtain the corresponding initial camera video grayscale frame and calculate the initial tracking point aggregation within the contour of this two-dimensional code; when the initial tracking point aggregation number is greater than the preset threshold value, to obtain the current camera video grayscale frame, previous tracking point aggregation and previous camera video grayscale frame; to take the current camera video grayscale frame, previous tracking point aggregation and previous camera video grayscale frame as the parameter to apply in the optic flow tracking modes so as to obtain the current tracking point aggregation that is tracked by the current camera video frame image; to calculate the homography matrix according to the corresponding dotted pairs of the initial tracking point aggregation and current tracking point aggregation.

Preferably, after obtaining the current tracking point aggregation that is tracked by the current camera video frame image, when it determined that this current tracking point aggregation exceeds the preset proportion of the initial tracking point aggregation, it shall further judge whether the current tracked number of camera video frame images is greater than the preset threshold value, if no, it shall calculate the homography matrix according to the corresponding dotted pairs of the initial tracking point aggregation and current tracking point aggregation.

The algorithm process provided by the embodiment of the present application can be divided into three modules in function, which are detection tracking module, information recognition module and information display module. The detection tracking module includes the function realization of two-dimensional code detection, two-dimensional code tracking and position information obtaining. The information recognition module includes the function realization of two-dimensional code recognition and content information obtaining. The information display module mainly includes the function realization of augmented reality display content.

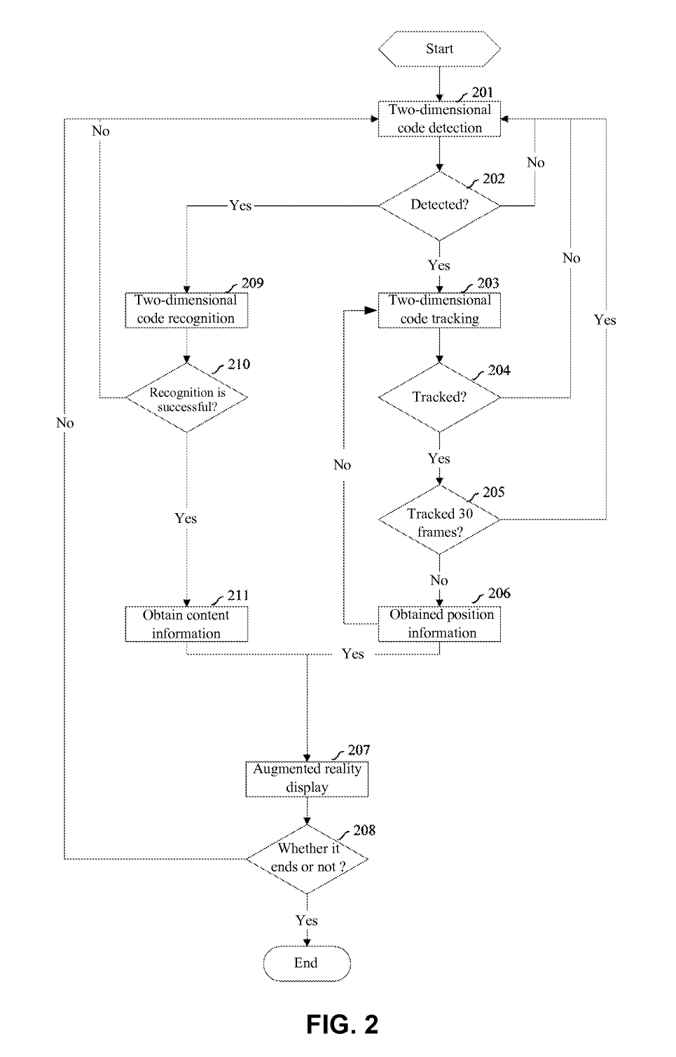

Based on the aforementioned analysis, FIG. 2 is a demonstration flowchart diagram of realization method of two-dimensional code augmented reality based on the embodiment of the present application.

As is shown in FIG. 2, the method includes:

Step 201: detecting two-dimensional code in camera video frame image, wherein the camera video frame image is the obtained image data in each video frame obtained by the camera.

Step 202: judging whether the two-dimensional code is detected, if yes, perform Step 209 and the following steps, and perform Step 203 and the following steps at the same time, if no, return to perform Step 201. That is to say, if the two-dimensional code is determined to be detected, then perform the two “yes” branches at the same time, one branch is to perform Step 203, Step 204, Step 205 and Step 206 orderly; the other branch is to perform Step 209, Step 210 and Step 211 orderly.

The first branch is described as follows:

Step 203: performing the two-dimensional code tracking processing.

Step 204: judging whether the two-dimensional code is tracked, if yes, perform Step 205 and the following steps, otherwise, perform Step 201 and the following steps.

Step 205: judging whether 30 frame have been tracked, if yes, return to perform Step 201 and the following steps, otherwise, perform Step 206.

Step 206: obtaining the position information of two-dimensional code. If the position information is obtained, proceed to step 207, but if not, return to step 203.

Thus far, determine that the first “yes” branch of two-dimensional code detected in Step 202 is performed completely.

The second branch is described as follows:

Step 209: after determining that the two-dimensional code is detected in Step 202, perform the two-dimensional code recognition.

Step 210: judging whether the two-dimensional code recognition is successful or not, if yes, perform Step 211, otherwise, return to perform Step 201.

Step 211: obtaining the content information of two-dimensional code. For example, the content information can be various forms such as URL, business card information and so on.

Thus far, determine that the second “yes” branch of two-dimensional code detected in Step 202 is performed completely.

When the two branches are all complete, perform Step 207 and Step 208.

Step 207: using the position information of two-dimensional code obtained in the first “yes” branch and the content information of two-dimensional code obtained in the second “yes” branch to perform the augmented reality display of two-dimensional code. For example, based on the position information of two-dimensional code, the content information of the two-dimensional code can be displayed in corresponding position of the camera video in the form of 2D video or 3D video.

Step 208: judging whether the process can be ended. If yes, end the process, if no, return to perform Step 201.

Taking QR two-dimensional code as an example, the process of two-dimensional code detection will be described in detail in the following.

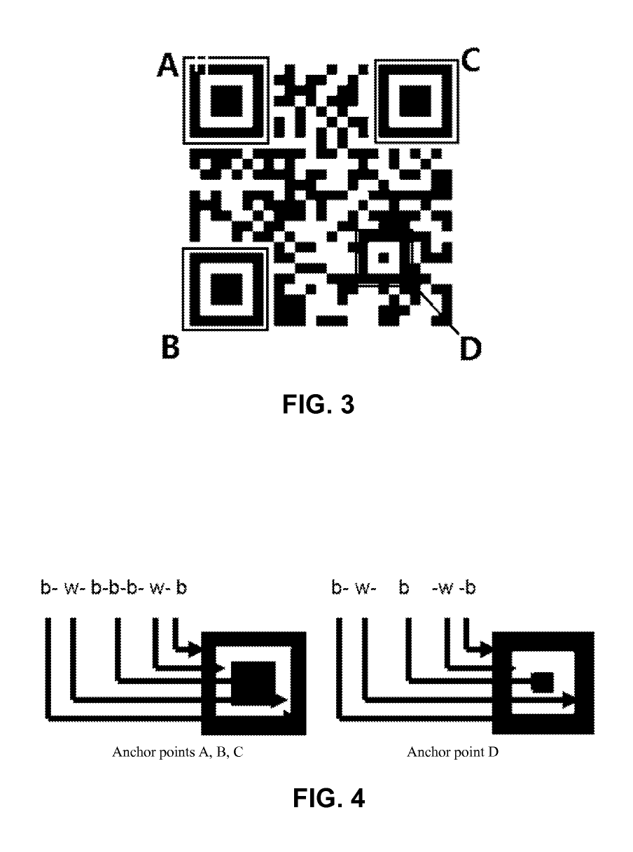

Firstly, the QR two-dimensional code is described. FIG. 3 is a schematic diagram of QR two-dimensional code anchor point based on the embodiment of the present application; FIG. 4 is a characteristic schematic diagram of QR two-dimensional code anchor point based on the embodiment of the present application.

In the two-dimensional code detection, the anchor point of QR two-dimensional code can be adopted for positioning. The definitions of the four anchor points of QR two-dimensional code is as FIG. 3 shown, the four anchor points can be defined as anchor point A, anchor point B, anchor point C, and anchor point D respectively. Meanwhile, the white pixel point in the image matrix of two-dimensional code can be defined as w, and the black pixel point as b.

According to the definition of international standard of two-dimensional code, the characteristics that the four anchor points of two-dimensional code need to satisfy are as follows: for the anchor point A, B and C, it is required to satisfy the type characteristic of b-w-b-b-b-w-b orderly when scanning from horizontal center line to vertical center line and from outside to inside shall be; for anchor point D, it is required to satisfy the type characteristic of b-w-b-w-b orderly, the description about this characteristic is as FIG. 4 shown.

Therefore, for the characteristic definition of QR two-dimensional code, in the process of detecting two-dimensional code in the image, it can be scanned twice, horizontally and vertically, firstly obtain the characteristic line of horizontal anchor point, then the characteristic line of vertical anchor, finally the intersection point of characteristic lines of horizontal anchor and vertical anchor, by this way, obtain the ultimate anchor point position. At the same time, by the position of anchor point, the embodiment of the present application can also calculate out homography matrix and two-dimensional code contour used for the following two-dimensional code tracking algorithm.

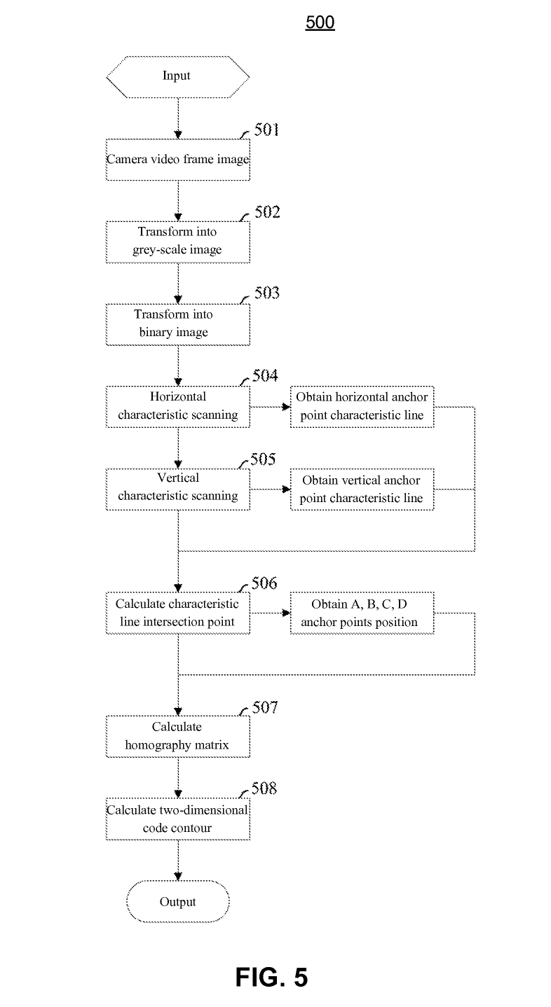

FIG. 5 is a flowchart diagram 500 of QR two-dimensional code detection method of the embodiment of the present application, as well as identification of the contour of the two-dimensional code and tracking of the identified contour (as in method 100 in FIG. 1).

As is shown in FIG. 5, the method includes:

Step 501: inputting camera video frame image.

Step 502: transforming the camera video frame image into grayscale image.

Here, for the input camera video frame images, supposing that the pixel values of the three color channels are R, G and B respectively, and the corresponding grayscale value is Y. Then the following formula can be used for transforming the color images into grayscale images:

$$Y = \frac{R \times 30 + G \times 59 + B \times 11}{100} .$$

Step 503: transforming to binary image.

Here, by demonstration, the Ni-black local binarization method can be adopted for the image binarization.

Step 504-506: performing the horizontal characteristic scanning and vertical characteristic scanning to calculate the intersection point of characteristic line.

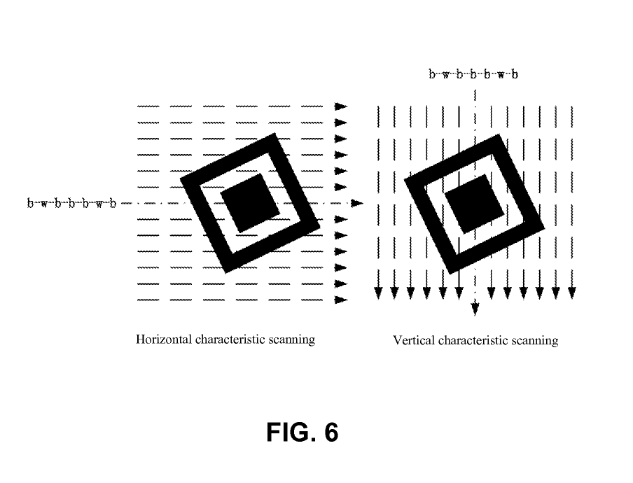

Here, FIG. 6 is a schematic diagram of horizontal and vertical characteristic scanning. Perform the horizontal and vertical scanning pixel by pixel for the image after binarization, based on the description of QR two-dimensional code characteristic mentioned in FIG. 4, it can be shown that, only by horizontal scanning process of center point of anchor point A, B and C of two-dimensional code, can the horizontal anchor point characteristic line with proportion of black pixel and white pixel of b-w-b-b-b-w-b type orderly be obtained, and only by vertical scanning process of center point of anchor point A, B and C of two-dimensional code, can the vertical anchor point characteristic line with proportion of black pixel and white pixel of b-w-b-b-b-w-b type orderly be obtained. Therefore, the center point of QR two-dimensional code anchor point A, B and C can be obtained by intersection point of characteristic lines of horizontal anchor point and vertical anchor point.

Similarly, based on the description of QR two-dimensional code characteristic mentioned in FIG. 4, it can be shown that, only by horizontal scanning process of center point of anchor point D of two-dimensional code, can the horizontal anchor point characteristic line with proportion of black pixel and white pixel of b-w-b-w-b type orderly be obtained, and only by vertical scanning process of center point of anchor point D of two-dimensional code, can the vertical anchor point characteristic line with proportion of black pixel and white pixel of b-w-b-w-b type orderly be obtained. Therefore, the center point of QR two-dimensional code anchor point D can be obtained by intersection point of characteristic lines of horizontal anchor point and vertical anchor point.

By the scanning process like this, three anchor points (marked as P1, P2 and P3) satisfying b-w-b-b-b-w-b type and one anchor point D satisfying b-w-b-w-b type can be positioned. According to the characteristic of two-dimensional code anchor point, the following method can be adopted to distinguish the three anchor points that satisfy b-w-b-b-b-w-b type: firstly calculate the distance between three anchor points and anchor point D, the farthest anchor point is anchor point A (supposing it is P1). Then connect vector \vec{DA}, \vec{DP}₂ and \vec{DP}₃. If \vec{DP}₂ is on the right of \vec{DA}, then P2 is the anchor point; if \vec{DP}₂ is on the left, \vec{DA} then P2 is anchor point C.

Step 507-508: calculate the homography matrix and two-dimensional code contour.

Here, supposing that the positions of anchor point A, B, C and D in original two-dimensional code image are (x₁, y₁), (x₂, y₂), (x₃, y₃) and (x₄, y₄) respectively; and supposing that the positions of anchor point A, B, C and D in the image needing to detect are (x′₁, y′₁), (x′₂, y′₂), (x′₃, y′₃) and (x′₄, y₄′) respectively. The following formula can be used to calculate homography matrix Homo of two-dimensional code.

$$( \begin{matrix}{x}_{i}^{′} \\ {y}_{i}^{′} \\ 1\end{matrix} ) = Homo \cdot ( \begin{matrix}{x}_{1} \\ {y}_{i} \\ 1\end{matrix} ) ,$$

wherein i=1 . . . 4.

Supposing that the positions of four edge corners in original two-dimensional code image are (px₁, py₁), (px₂, py₂), (px₃, py₃) and (px₄, py₄) respectively, by the above mentioned formula, it can be calculated out that the positions of four edge corners of two-dimensional code in the image needing to detect are (px′₁, py′₁), (px′₂, py′₂), (px′₃, py′₃) and (px′₄, py′₄) respectively. The two-dimensional code contour in detection image can be obtained thus far.

What needs to specially note is that, in actual application, the embodiment of the present application can also be combined with the following modes properly to increase the detection rate of two-dimensional code: for the input camera video frame image, if the two-dimensional code cannot be detected, then conduct down-sampling with proportion of 0.5, and continue two-dimensional code detection on the image after down-sampling, if the two-dimensional code is not detected, then continue down-sampling with proportion of 0.5 and repeat for three times. If it is also impossible to scan two-dimensional code after repeating for three times, then it can be recognized that the two-dimensional code is not detected. In this process, different down-sampling proportion of 0.5, 0.6, 0.7 and 0.8 can be adopted according to the actual condition.

In the following, continue to take QR two-dimensional code as an example to describe the two-dimensional code tracking process of embodiment of the present application. Because the camera is often in moving state in application of augmented reality, the tracking processing is also required for two-dimensional code after detecting the two-dimensional code.

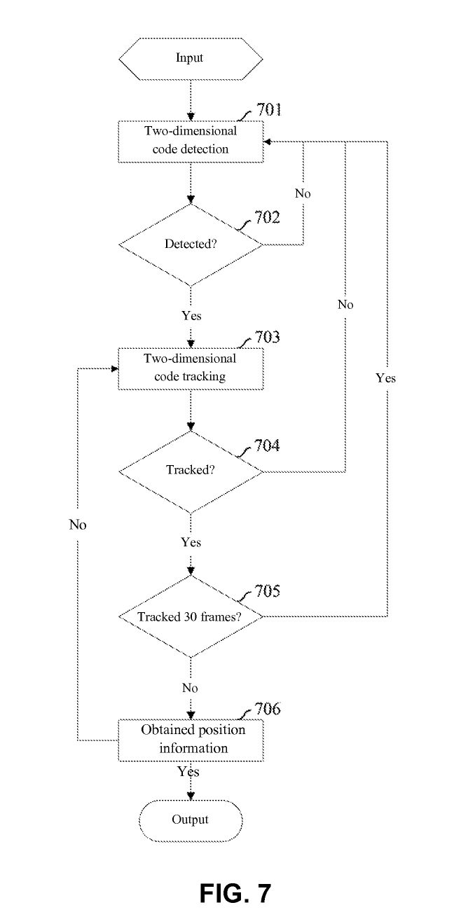

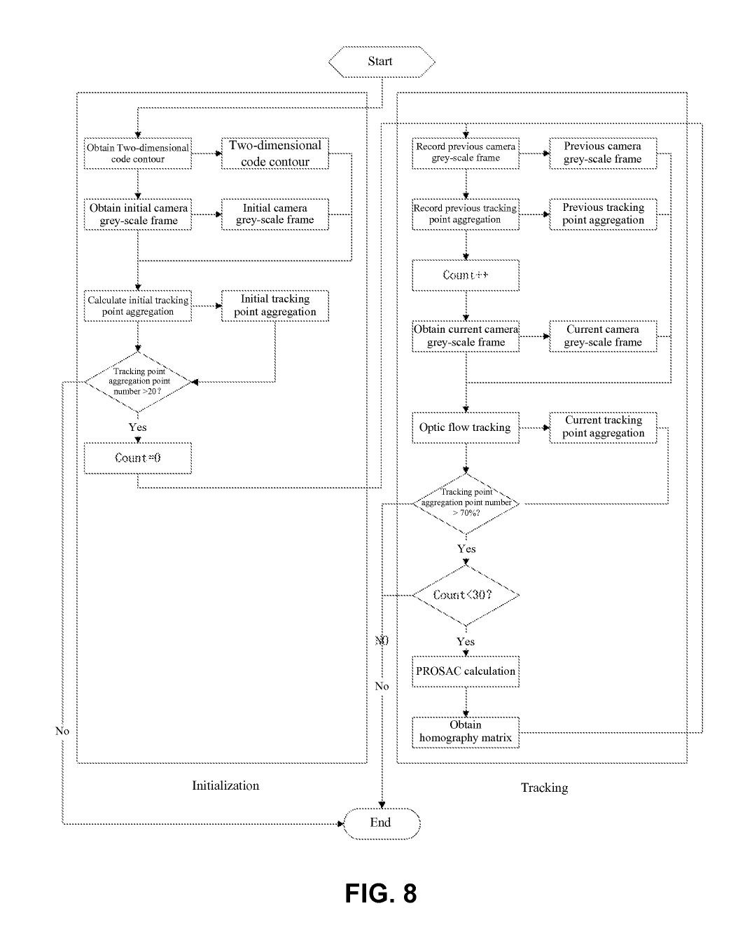

FIG. 7 is a flowchart diagram of two-dimensional code detection and tracking based on the embodiment of the present application.

As is shown in FIG. 7, the method includes:

Step 701: performing the two-dimensional code detection.

Step 702: judging whether the two-dimensional code is detected, if yes, perform Step 703 and the following steps, otherwise, return to perform Step 701 and the following steps.

Step 703: performing the two-dimensional code tracking.

Step 704: judging whether the two-dimensional code is tracked, if yes, perform Step 705 and the following steps, otherwise, return to perform Step 701 and the following steps.

Step 705: judging whether 30 frames have been tracked, if no, perform Step 706, if yes, perform Step 701.

Step 706: obtaining the position information of two-dimensional code. If the position information is obtained, proceed to Output, otherwise go back to Step 703.

In some embodiments, the “Good Feature to Track” method (Shi and C. Tomasi. “Good Features to Track”. Proceedings of the IEEE Conference on Computer Vision and Pattern Recognition, pages 593-600, June 1994) can be used to obtain the corner point aggregation needing to track, and the optic flow tracking method can be used to track the corner point aggregation. The tracking process of two-dimensional code can be divided into two parts, initialization and tracking.

FIG. 8 is a demonstrative flowchart diagram of two-dimensional code tracking based on the embodiment of the present application. As is shown in FIG. 8, the tracking process of two-dimensional code can be divided into two parts, initialization and tracking.

Initialization part: initialization process of two-dimensional code tracking, Step I: record the grayscale frame corresponding to the obtained two-dimensional code contour according to the two-dimensional code detection module. Step II: in the two-dimensional code contour obtained in two-dimensional code detection, use the “Good Feature to Track” algorithm to find out the initial tracking point aggregation suitable for tracking Step III: judge the number of initial tracking point aggregation, if the number is larger than 20, then continue the following tracking process, taking the initial grayscale frame as previous grayscale frame and the initial tracking point aggregation as previous tracking point aggregation; if the number is smaller than 20, then do not track.

Tracking part: the tracking process of two-dimensional code, Step I: obtain the current camera grayscale frame, the previous tracking point aggregation and the previous camera grayscale frame. Step II: using optic flow tracking method to obtain the current tracking point aggregation tracked by the current camera video frame image from the three parameters obtained in the previous step. Step III: judge whether the current tracking point aggregation exceeds 70% of the initial tracking point aggregation, if yes, conduct the next step, if no, end it. Step IV: judge the current tracked frame number, if more than 30 frames are tracked, end it, if no, conduct the next step. Step V: using the PROSAC and other algorithm for corresponding point pairs of initial tracking point aggregation with current tracking point aggregation to calculate the homography matrix Homo′ of initial frame to current frame, then the homography matrix of original two-dimensional code can be obtained by multiplying detected Homo and tracked Homo′.

In the aforementioned method, for the recognition of two-dimensional code augmented reality, the embodiment of the present application can adopt the recognition algorithm provided by ZBar. The recognition engine has function of recognizing standard QR two-dimensional code and can obtain coding information and position information of QR two-dimensional code. But its operation speed is a little slow. In the present application, while taking the frame which can obtain two-dimensional code image by detection as input of ZBar algorithm, do not conduct two-dimensional code recognition again for the tracked frame before starting detection again, and the operation times of two-dimensional code recognition algorithm is decreased in a large extent, which will ensure real-time of the system.

In embodiment of the present application, two-dimensional code augmented reality can be displayed with two modes based on content to display, and one is to display plane video in the position of two-dimensional code, another is to display 3D model or animation in the position of two-dimensional code. There are two different processing modes based on two different display modes.

For mode of displaying plane video: for display mode to display plane video in the position of two-dimensional code, at first, embodiment of the present application transforms display video frame image into the size of original two-dimensional code image. Supposing that (x, y) corresponds to original position of display video frame image, supposing that (x′, y′) corresponds to the position after display video frame image is transformed, w′ and h′ correspond to width and height of original two-dimensional code, w and h serving as width and height of original display video frame image, and the formula are as follows:

$$( \begin{matrix}{x}^{′} \\ {y}^{′} \\ 1\end{matrix} ) = ( \begin{matrix}{s}_{x} & 0 & 1 \\ 0 & {s}_{y} & 1 \\ 0 & 0 & 0\end{matrix} ) ( \begin{matrix}x \\ y \\ 1\end{matrix} ) ,$$

wherein:

$${s}_{x} = \frac{{w}^{′}}{w} , {s}_{y} = \frac{{h}^{′}}{h} ;$$

Supposing that (x″, y″) corresponds to the position of two-dimensional code in the camera video frame image, therefore, it can be shown from homography matrix definition that transformation matrix of corresponding positions from display video frame image into camera video frame image is shown in the following formula:

$$( \begin{matrix}{x}^{″} \\ {y}^{″} \\ 1\end{matrix} ) = Homo \cdot ( \begin{matrix}{s}_{x} & 0 & 1 \\ 0 & {s}_{y} & 1 \\ 0 & 0 & 0\end{matrix} ) ( \begin{matrix}x \\ y \\ 1\end{matrix} ) ;$$

For display video image of each frame,

$$Homo \cdot ( \begin{matrix}{s}_{x} & 0 & 1 \\ 0 & {s}_{y} & 1 \\ 0 & 0 & 0\end{matrix} )$$

shall be used for transformation as transformation matrix, after that transformed display video frame image is superposed on camera video frame image, realizing display effect of augmented reality.

For mode of displaying 3D model and animation: for display mode to display 3D model and animation in the position of two-dimensional code, embodiment of the present application uses the following formula to obtain projection matrix from three-dimensional coordinates (world coordinate system) of 3D model or animation to screen display through internal parameter and external parameter.

Through perspective transformation, a frame view enables to project points in three-dimensional space to image plane. The formula is as follows:

$$s \cdot {m}^{′} = A \cdot [ R \vert t ] \cdot {M}^{′} ;$$

$$Or$$

$$s \cdot [ \begin{matrix}u \\ υ \\ 1\end{matrix} ] = [ \begin{matrix}fx & 0 & cx \\ 0 & fy & cy \\ 0 & 0 & 1\end{matrix} ] \cdot [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] \cdot [ \begin{matrix}X \\ Y \\ Z \\ 1\end{matrix} ] ;$$

(X, Y, Z) of this formula is world coordinates of one point; (u, v) is coordinates of point projected on image plane, with pixel as unit; A is named as camera matrix, or internal parameter matrix; (cx, cy) is reference point (usually in the center of the image); fx, fy is focal length with pixel as unit. If conducting upsampling or downsampling for a frame of image from camera owing to some factors, all of these parameters (fx, fy, cx, cy) will be scaled (multiplied or divided) at the same scale. Internal parameter matrix is independent of image of scene, once calculated, allowing repeated use (as long as focal length is fixed). Rotation—translation matrix [R|t] is named as external parameter matrix, which is used to describe motion of camera relative to a fixed scene, or by contrast, rigid motion of object around camera. That is, [R|t] swifts coordinates point (X, Y, Z) to a certain coordinate system which is fixed relative to camera.

The transformation above is equivalent to the following form (z≠0):

$$[ \begin{matrix}x \\ y \\ z\end{matrix} ] = R \cdot [ \begin{matrix}X \\ Y \\ Z\end{matrix} ] + t ;$$

$${x}^{′} = x / z ;$$

$${y}^{′} = y / z ;$$

$$u = fx \cdot {x}^{′} + cx ;$$

$$υ = fy \cdot {y}^{′} + cy ;$$

Generally, there is some deformation for real lens, and major deformation is radial deformation, in addition, there will be slight tangential deformation. So the model above can be extended as:

$$[ \begin{matrix}x \\ y \\ z\end{matrix} ] = R \cdot [ \begin{matrix}X \\ Y \\ Z\end{matrix} ] + t ;$$

$${x}^{′} = x / z ;$$

$${y}^{′} = y / z ;$$

$${x}^{″} = {x}^{′} \cdot ( 1 + {k}_{1} \cdot {r}^{2} + {k}_{2} \cdot {r}^{4} ) + 2 \cdot {p}_{1} \cdot {x}^{′} \cdot {y}^{′} + {p}_{2} \cdot ( {r}_{2} + 2 {x}^{′2} )$$

$${y}^{″} = {y}^{′} \cdot ( 1 + {k}_{1} \cdot {r}^{2} + {k}_{2} \cdot {r}^{4} ) + {p}_{1} \cdot ( {r}_{2} + 2 \cdot {y}^{′2} ) + 2 \cdot {p}_{2} \cdot {x}^{′} \cdot {y}^{′}$$

Here, r2=x′2+y′2;

u=fx·x″+cx;

v=fy·y″+cy;

k1 and k2 are radial deformation coefficients, and p1 and p2 are tangential deformation coefficients. The present application uses RPP (Robust Pose estimation from a Planar target) algorithm for obtaining the aforementioned R and t. Transformation matrix from world coordinates (X, Y, Z) of 3D model to plane coordinates (u, v) of projection screen can be derived from this. Using OpenGL and other computer graphics display libraries, this matrix can be used for displaying the position of two-dimensional code where 3D model is superposed on camera video frame image, realizing effect of augmented reality.

In the above description, the adopted augmented reality recognition scheme uses recognition algorithm provided by ZBar open-source library, and in practical application, likewise embodiment of the present application can use ZXing and other two-dimensional code recognition algorithms.

In the above description, use corner point selection algorithm of the “Good Feature to Track” and corner point track algorithm of optic flow track to track two-dimensional code. In practical application, embodiment of the present application can use likewise FAST, Harris and other corner point selection algorithms or Kalman Filtering and other feature point track algorithms.

In the above description, using RPP (Robust Pose estimation from a Planar target) to conduct projection transformation matrix from 3D model to plane, in practical application, likewise, embodiment of the present application also can use pose estimation of EPnP etc.

In the above description, embodiment of the present application is explained in detail with QR two-dimensional code as an example. Technical staff in this field will recognize that embodiment of the present application is not limited to QR two-dimensional code, but applicable to any two-dimensional code.

Thus it can be seen that, in embodiment of the present application, two-dimensional code detection is separated from its recognition process, and through conducting two-dimensional code recognition until detecting that two-dimensional code can be obtained, recognition processing of two-dimensional code with slower operation is reduced.

In addition, two-dimensional code detection is separated from its tracking process by the embodiment of the present application, through tracking feature point of two-dimensional code contour allowing obtaining two-dimensional code, restart detection until tracking loss satisfies certain condition, this method reduces detection process performance times of two-dimensional code with slower operation and lower detection success rate, increases calculation speed of two-dimensional code and improves stability and continuity of obtaining the position of two-dimensional code.

In the embodiment of the present application, QR two-dimensional code can make the amount of information stored in it extends freely with flexible extensible code format. Symbol specifications are from Version 1 (21×21 module) to Version 40 (177×177 module), whenever improving a version, 4 modules will be added for each side. The maximum Version 40 can generally accept number data: 7,089 characters, letter data: 4,296 characters, 8-bit bytes data: 2,953 characters, Chinese/Japanese Chinese character data: 1,817 characters. When there is large amount of information, only expanding the contents of the QR two-dimensional code data can adapt to coding with larger data size.

Furthermore, the QR two-dimensional code used in the embodiment of the present application is international standard data format. QR two-dimensional code is a kind of matrix two-dimensional code symbol researched by Japan Denso Corporation in September, 1994, it has many advantages contained by single-dimensional bar code and other two-dimensional bar code, such as large information capacity, high reliability, the ability to express many kinds of literal information, like Chinese characters and images, and high security and anti-falsification, etc. Standard JIS X 0510 of Japan QR code was published in January, 1999, but its corresponding ISO International Standard ISO/IEC18004 was approved in June, 2000. Chinese National Standard GB/T 18284-2000 was also published in 2000. All these indicate that QR two-dimensional code is a kind of general format, which has got the international recognition, comparing with other two-dimensional code and self-defined zone bit, its code format has greater generality and normative.

Moreover, QR two-dimensional code recognition algorithm used in the embodiment of the present application is simple and fast (generally 50-100 ms on common PC computer), at the same time, QR two-dimensional code itself has contained many information, so it can also not need the support of back end database.

In the embodiment of the present application, the detection methods aiming at two-dimensional code augmented reality include: adopting twice scanning in the horizontal direction and vertical direction according to the anchor point characteristics of two-dimensional code, obtaining the horizontal anchor point characteristic line and vertical anchor point characteristic line according to the proportion characteristic of black pixel and white pixel of anchor point. Calculate the intersection points according to the horizontal anchor point characteristic line and vertical anchor point characteristic line, distinguish anchor points A, B, C through the distances and vector direction relations between anchor point D and other anchor points. Carry out the detection for the images with many times downsampling to improve two-dimensional code detection rate.

In the embodiment of the present application, the tracking methods aiming at two-dimensional code augmented reality include: use the two-dimensional code contour obtained by two-dimensional code detection to extract the initialization characteristic point for the points in contour. Carry out characteristic point tracking for the initialization characteristic points in contour. Restart detection process based on the certain tracking loss rate and tracking time is fulfilled.

In the embodiment of the present application, the display methods aiming at two-dimensional code augmented reality include: use different display artifice according to different display mode. Among which, aiming at two-dimensional plane video, adopt homography matrix as transformation matrix to transform image; aiming at 3D model or animation, adopt method for pose estimation.

Based on the aforementioned specific analysis, the embodiment of this invention also puts forward a kind of realization device of two-dimensional code augmented reality.

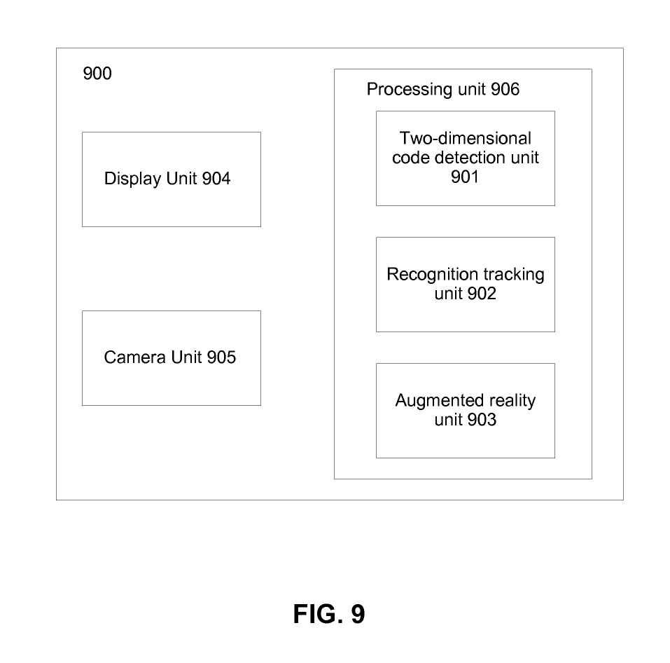

FIG. 9 is a structural diagram of realization device 900 of two-dimensional code augmented reality based on the embodiment of the present application.

As is shown in FIG. 9, this device includes: a display unit 904, a camera unit 905, and a processing unit 906 comprising a two-dimensional code detection unit 901, recognition tracking unit 902 and augmented reality unit 903, among which:

Two-dimensional code detection unit 901: configured to detect image capture of the two-dimensional code in the camera video frame image so as to obtain the contour of two-dimensional code;

Recognition tracking unit 902: configured to recognize this two-dimensional code that the contour of two-dimensional code is detected so as to obtain the content information of the two-dimensional code, and track this two-dimensional code that the contour of two-dimensional code is detected so as to obtain the position information of two-dimensional code in the camera video frame image;

Augmented reality unit 903: configured to perform the augmented reality processing on the two-dimensional code based on the content information of mentioned two-dimensional code and position information of two-dimensional code in the camera video frame image, and generate the augmented reality on the device while simultaneously displaying real-world imagery on the display of the device.

Display unit 904 is configured to display real-world imagery and visual augmented reality, and camera unit 905 is configured to capture images and video through a camera video frame.

In an embodiment, the mentioned two-dimensional code is specifically quick-response QR two-dimensional code.

In an embodiment, two-dimensional code detection unit 901 is configured to transform the camera video frame image to grayscale image, and transform the mentioned grayscale image into binary image;

To execute the horizontal anchor point characteristic scanning and vertical anchor point characteristic scanning against this binary image so as to obtain the horizontal anchor point characteristic line and vertical anchor point characteristic line;

To calculate the intersection point between the horizontal anchor point characteristic line and vertical anchor point characteristic line so as to obtain the position of anchor point of QR two-dimensional code;

To obtain the contour of this QR two-dimensional code according to the calculated position of anchor point of QR two-dimensional code.

In an embodiment, two-dimensional code detection unit 901 is further configured when no two-dimensional code is detected in the camera video frame image, then perform downsampling treatment against this camera video frame image, and detect the two-dimensional code in the camera video frame image after performing the downsampling treatment.

In an embodiment, the mentioned two-dimensional code is specifically quick-response QR two-dimensional code; at this moment, recognition tracking unit 902 is configured to obtain the corresponding initial camera video grayscale frame according to the contour of two-dimensional code and calculate the initial tracking point aggregation within the contour of this two-dimensional code.

When the initial tracking point aggregation number is greater than the preset threshold value, to obtain the current camera video grayscale frame, previous tracking point aggregation and previous camera video grayscale frame.

To take the current camera video grayscale frame, previous tracking point aggregation and previous camera video grayscale frame as the parameter to apply in the optic flow tracking modes so as to obtain the current tracking point aggregation that is tracked by the current camera video frame image.

To calculate the homography matrix according to the corresponding dotted pairs of the initial tracking point aggregation and current tracking point aggregation.

In an embodiment, recognition tracking unit 902 is further configured after obtaining the current tracking point aggregation that is tracked by the current camera video frame image, when it determines that this current tracking point aggregation exceeds the preset proportion of the initial tracking point aggregation, it shall further judge whether the current tracked number of camera video frame images is greater than the preset threshold value, if no, it shall calculate the homography matrix according to the corresponding dotted pairs of the initial tracking point aggregation and current tracking point aggregation.

In an embodiment, augmented reality unit 903 is further configured to display plane video in the position of the two-dimensional code based on the content information of mentioned two-dimensional code and position information of two-dimensional code in the camera video frame image.

In an embodiment, augmented reality unit 903 is configured to invert the size of displaying video image into the size of original two-dimensional code image; conducting transformation for the displaying video frame image according to the position information of two-dimensional code in camera video frame image, and superposing the transformed displaying video frame image in the camera video frame image.

In an embodiment, augmented reality unit 903 is further configured to display 3D model in the position of the two-dimensional code based on the content information of mentioned two-dimensional code and position information of two-dimensional code in the camera video frame image.

In an embodiment, augmented reality unit 903 is further configured to calculate transformation matrix of world coordinate of 3D model to plane coordinate of projection screen; using the transformation matrix to overlay the 3D model in the camera video frame image according to the position information of two-dimensional code in the camera video frame image.

It is acceptable to integrate the device shown in FIG. 9 into hardware entities of a variety of networks. For example, the realization device for the augmented reality of two-dimensional code is allowed to be integrated into: devices including feature phone, smart phone, palmtop, personal computer (PC), tablet computer or personal digital assistant (PDA), etc.

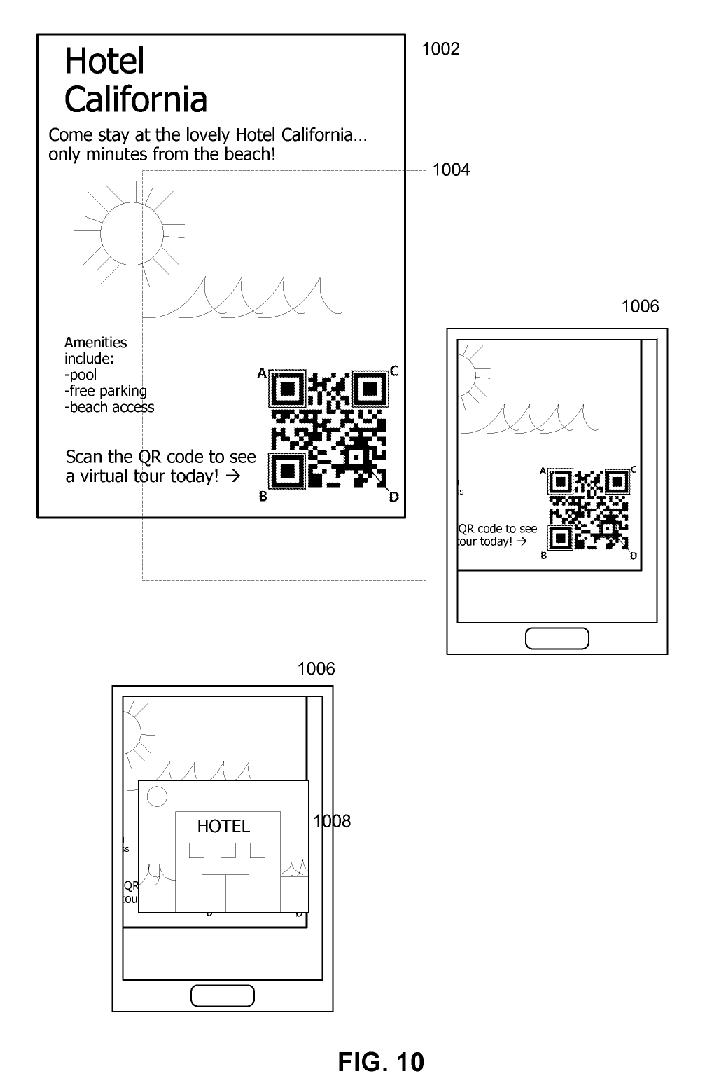

FIG. 10 is an exemplary representation of an embodiment of the present application demonstrating detection of a two-dimensional code and display of corresponding augmented reality information. Object 1002 represents an exemplary object (e.g., magazine advertisement), comprising a two-dimensional code, such as a QR code. In FIG. 10, object 1002 is a magazine advertisement for a hotel, comprising a two-dimensional code (e.g., QR code) that a user can scan with a portable electronic device 1006 (e.g., a smartphone, PDA, tablet), in order to see a representation of the content information contained in the two-dimensional code 1008 (e.g., virtual tour of the hotel). In some embodiments, the representation of the content information 1008 is textual, graphical, audio, or video information, or a combination of any of the above. In some embodiments, the representation of the content information 1008 is a 3D image or video, and in some embodiments the representation of the content information 1008 is displayed in the area occupied by the two-dimensional code in the camera video frame of device 1006.

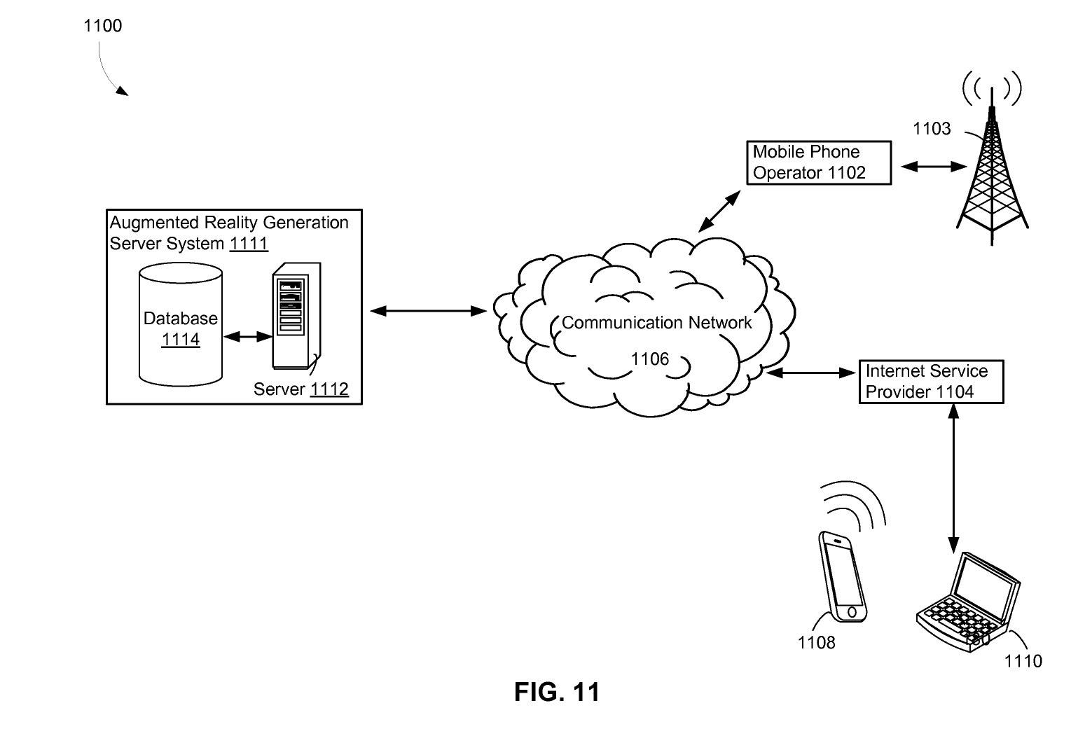

FIG. 11 is a diagram of a client-server environment 1100 for augmented reality generation, in accordance with some implementations. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 1100 includes one or more mobile phone operators 1102, one or more internet service providers 1104, and a communications network 1106.

The mobile phone operator 1102 (e.g., wireless carrier), and the Internet service provider 1104 are capable of being connected to the communication network 1106 in order to exchange information with one another and/or other devices and systems. Additionally, the mobile phone operator 1102 and the Internet service provider 1104 are operable to connect client devices to the communication network 1106 as well. For example, a smart phone 1108 is operable with the network of the mobile phone operator 1102, which includes for example, a base station 1103. Similarly, for example, a laptop computer 1110 (or tablet, desktop, smart television, workstation or the like) is connectable to the network provided by an Internet service provider 1104, which is ultimately connectable to the communication network 1106.

The communication network 1106 may be any combination of wired and wireless local area network (LAN) and/or wide area network (WAN), such as an intranet, an extranet, including a portion of the Internet. It is sufficient that the communication network 1106 provides communication capability between client devices (e.g., smart phones 1108 and personal computers 1110) and servers. In some implementations, the communication network 1106 uses the HyperText Transport Protocol (HTTP) to transport information using the Transmission Control Protocol/Internet Protocol (TCP/IP). HTTP permits a client device to access various resources available via the communication network 1106. However, the various implementations described herein are not limited to the use of any particular protocol.

In some implementations, the client-server environment 1100 further includes an augmented reality generation server system 1111. Within the augmented reality generation server system 1111, there is a server computer 1112 (e.g., a network server such as a web server) for receiving and processing data received from the client device 1108/1110 (e.g., capture of two-dimensional code). In some implementations, the augmented reality generation server system 1111 stores (e.g., in a database 1114) and maintains augmented reality information corresponding to a plurality of registered two-dimensional codes.

In some implementations, the augmented reality generation server system 1111 sends to a client device 1108/1110 an augmented reality model for a respective two-dimensional code using a received two-dimensional code from the client device 1108/1110 and retrieves the augmented reality model from database 814.

Those skilled in the art will appreciate from the present disclosure that any number of such devices and/or systems may be provided in a client-server environment, and particular devices may be altogether absent. In other words, the client-server environment 1100 is merely an example provided to discuss more pertinent features of the present disclosure. Additional server systems, such as domain name servers and client distribution networks may be present in the client-server environment 1100, but have been omitted for ease of explanation.

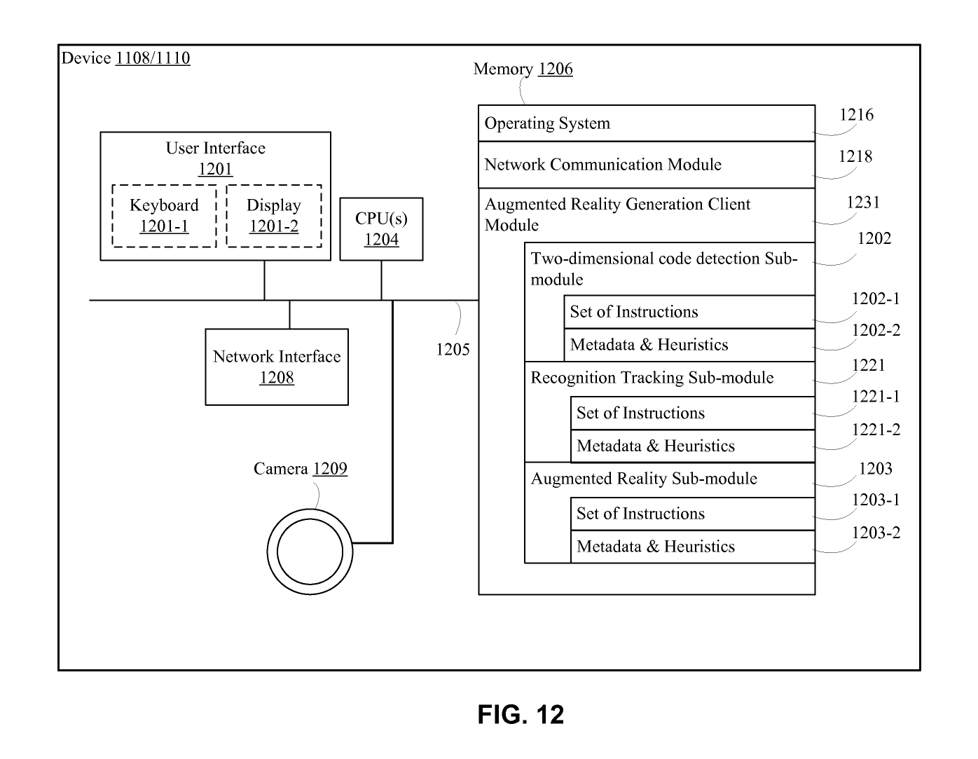

FIG. 12 is a diagram of an example implementation of the device 1108/1110 for augmented reality generation, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

Device 1108/1110 includes one or more processing units (CPU's) 1204, one or more network or other communications interfaces 1208, a user interface 1201 (optionally comprising elements such as a keyboard 1201-1 or display 1201-2), memory 1206, a camera 1209, and one or more communication buses 1205 for interconnecting these and various other components. The communication buses 1205 may include circuitry (sometimes called a chipset) that interconnects and controls communications between system components. Memory 1206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1206 may optionally include one or more storage devices remotely located from the CPU(s) 1204. Memory 1206, including the non-volatile and volatile memory device(s) within memory 1206, comprises a non-transitory computer readable storage medium.

In some implementations, memory 1206 or the non-transitory computer readable storage medium of memory 1206 stores the following programs, modules and data structures, or a subset thereof including an operating system 1216, a network communication module 1218, and an augmented reality generation client module 1231.

The operating system 1216 includes procedures for handling various basic system services and for performing hardware dependent tasks.

The network communication module 1218 facilitates communication with other devices via the one or more communication network interfaces 1208 (wired or wireless) and one or more communication networks, such as the internet, other wide area networks, local area networks, metropolitan area networks, and so on.

In some implementations, the augmented reality generation client module 1231 includes a two-dimensional code detection sub-module 1202 for detecting an image capture of a two-dimensional code in the camera video frame image so as to obtain the contour of the two-dimensional code (e.g., to detect the corners of a QR code in the camera video frame). To this end, the two-dimensional code detection sub-module 1202 includes a set of instructions 1202-1 and, optionally, metadata 1202-2. In some implementations, the augmented reality generation client module 1231 includes a recognition tracking sub-module 1221 having a set of instructions 1221-1 (e.g., for obtaining the content information of the two-dimensional code, and tracking this two-dimensional code so as to obtain the position information of the two-dimensional code in the camera video frame image) and, optionally, metadata 1221-2, as well as an augmented reality sub-module 1203 having a set of instructions 1203-1 and optionally metadata 1203-2.

In fact, there are various forms to implement specifically the realization device for the augmented reality of two-dimensional code mentioned in the embodiment of the present application. For example, through application interface following certain specifications, the realization device for the augmented reality of two-dimensional code can be written as plug-in installed in browser, and packaged as application used for downloading by users themselves as well. When written as plug-in, it is allowed to be implemented as various plug-in forms including ocx, dll, cab, etc. And it is acceptable to implement the realization device for the augmented reality of two-dimensional code mentioned in the embodiment of the invention through specific technologies including Flash plug-in, RealPlayer plug-in, MMS plug-in, MI stave plug-in, ActiveX plug-in, etc.

Through storage methods of instruction or instruction set, the method for the augmented reality of two-dimensional code mentioned in the embodiment of the invention can be stored in various storage media. These storage media include but not limited to: floppy disk, CD, DVD, hard disk, Nand flash, USB flash disk, CF card, SD card, MMC card, SM card, Memory Stick (Memory Stick), xD card, etc.

In addition, the method for the augmented reality of two-dimensional code mentioned in the embodiment of the invention can also be applied to storage medium based on Nand flash, for example, USB flash disk, CF card, SD card, SDHC card, MMC card, SM card, Memory Stick, xD card and so on.

In summary, in the embodiment of the present application, detect two-dimensional code in the camera video frame image to obtain two-dimensional code contour, recognize the two-dimensional code detecting out the contour of two-dimensional code to obtain the content information of two-dimensional code, and track the two-dimensional code detecting out the contour of two-dimensional code to obtain the position information of two-dimensional code in the camera video frame image; perform the augmented reality processing on the two-dimensional code based on the content information of mentioned two-dimensional code and position information of two-dimensional code in the camera video frame image. Thus it can be seen, after the embodiment of the present application, two-dimensional code detection is separated from recognition process, just carry out two-dimensional code recognition for the situation that detection can obtain two-dimensional code, which reduces two-dimensional code recognition processing with low calculation.

Moreover, the embodiment of the present application separates the two-dimensional code detection and tracking process, just track the characteristic points for the two-dimensional code contour that detection can obtain two-dimensional code, restart the detection when tracking loss meets certain conditions, this method reduces detection process performance times of two-dimensional code with slower operation and lower detection success rate, the speed of two-dimensional code calculation is increased, and the stability and continuity of obtaining two-dimensional code position are improved.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of generating augmented reality at an electronic device with a camera and a display, comprising:
detecting an image capture of a two-dimensional code through a camera video frame;
identifying the contour of the two-dimensional code captured in the camera video frame;
decoding the information embedded in the detected two-dimensional code;
obtaining content information corresponding to the decoded two-dimensional code;
tracking the identified contour of the two-dimensional code within the camera video frame to obtain the position information of the two-dimensional code in the camera video frame;
performing augmented reality processing on the two-dimensional code based on the content information and the position information; and
generating the augmented reality on the device while simultaneously displaying real-world imagery on the display of the device, wherein any visual augmented reality is displayed in accordance with the location of the two-dimensional code in the video frame.

2. The method of claim 1, wherein the two-dimensional code is a quick-response (QR) code.

3. The method of claim 2, wherein detecting image capture of a two-dimensional code through a camera imaging frame includes converting the image capture to grayscale and converting the grayscale image capture to a binary image capture; and
identifying the contour of the two-dimensional code further includes:
executing the horizontal anchor point characteristic scanning and vertical anchor point characteristic scanning against this binary image;
obtaining a horizontal anchor point characteristic line and a vertical anchor point characteristic line;
calculating the intersection point between the horizontal anchor point characteristic line and vertical anchor point characteristic line;
obtaining the position of an anchor point of the QR two-dimensional code, corresponding to the calculated intersection point;
obtaining the contour of QR two-dimensional code in accordance with the calculated position of the anchor point.

4. The method of claim 3, wherein tracking the identified contour of the two-dimensional code within the imaging frame to obtain the position information of the two-dimensional code in the imaging frame further includes:
obtaining an initial camera video grayscale frame and calculating an initial tracking point aggregation within the contour of the two-dimensional code;
obtaining a current camera video grayscale frame, a previous tracking point aggregation and previous camera video grayscale frame, in accordance with a determination that the initial tracking point aggregation number is greater than a predetermined threshold value;
calculating a current tracking point aggregation, tracked by the current camera video frame image, by applying the current camera video grayscale frame, previous tracking point aggregation and previous camera video grayscale frame in optic flow tracking modes;
calculating a homography matrix in accordance with corresponding dotted pairs of the initial tracking point aggregation and current tracking point aggregation.

5. The method of claim 4, wherein calculating a homography matrix further includes:
determining that the current tracking point aggregation does not exceed the predetermined threshold value of the initial tracking point aggregation; and
calculating the homography matrix in accordance with a determination that the current tracked number of camera video frame images is less than the preset threshold value.

6. The method of claim 1, further comprising:
performing down sampling processing against the camera video frame image and reattempting to detect the two-dimensional code in the camera video frame image, in accordance with a determination that no two-dimensional code is detected in a camera video frame image of the camera video frame.

7. The method of claim 1, further comprising:
terminating the presentation of the augmented reality on the device, in accordance with a determination that no two-dimensional code is detected in a camera video frame image of the camera video frame.

8. The method of claim 1, wherein the generating the augmented reality on the device further comprises:
displaying the augmented reality on the display of the device and in the area occupied by the two-dimensional code in the camera video frame.

9. The method of claim 8, wherein the displaying the augmented reality on the display of the device and only in the area occupied by the two-dimensional code in the camera video frame further comprises:
converting the size of the augmented reality into the size of the captured two-dimensional code image in the camera video frame.

10. The method of claim 8, wherein the displayed augmented reality is a three-dimensional representation, based on the content and position information of the two-dimensional code.

11. The method of claim 10, wherein the displaying the augmented reality on the display of the device and only in the area occupied by the two-dimensional code in the camera video frame further comprises:
calculating a transformation matrix of polar coordinates of a three-dimensional model to the two-dimensional coordinates of the display screen; and
using the transformation matrix to overlay the three-dimensional model in the camera video frame image according to the position information of the two-dimensional code in camera video frame image.

12. An electronic device, comprising:
a display;
a camera;
one or more processors;
memory; and
one or more programs, wherein the one or more programs are stored in the memory and configured to be executed by the one or more processors, the one or more programs including instructions for:
detecting an image capture of a two-dimensional code through a camera video frame;
identifying the contour of the two-dimensional code captured in the camera video frame;
decoding the information embedded in the detected two-dimensional code;
obtaining content information corresponding to the decoded two-dimensional code;
tracking the identified contour of the two-dimensional code within the camera video frame to obtain the position information of the two-dimensional code in the camera video frame;
performing augmented reality processing on the two-dimensional code based on the content information and the position information; and
generating the augmented reality on the device while simultaneously displaying real-world imagery on the display of the device, wherein any visual augmented reality is displayed in accordance with the location of the two-dimensional code in the video frame.

13. The device of claim 12, wherein the two-dimensional code is a quick-response (QR) code.

14. The device of claim 13, wherein detecting image capture of a two-dimensional code through a camera imaging frame includes converting the image capture to grayscale and converting the grayscale image capture to a binary image capture; and
identifying the contour of the two-dimensional code further includes:
executing the horizontal anchor point characteristic scanning and vertical anchor point characteristic scanning against this binary image;
obtaining a horizontal anchor point characteristic line and a vertical anchor point characteristic line;
calculating the intersection point between the horizontal anchor point characteristic line and vertical anchor point characteristic line;
obtaining the position of an anchor point of the QR two-dimensional code, corresponding to the calculated intersection point;
obtaining the contour of QR two-dimensional code in accordance with the calculated position of the anchor point.

15. The device of claim 12, further including instructions for:
performing down sampling processing against the camera video frame image and attempting to detect the two-dimensional code in the camera video frame image, in accordance with a determination that no two-dimensional code is detected in a camera video frame image of the camera video frame.

16. The device of claim 12, further including instructions for:
terminating the presentation of the augmented reality on the device, in accordance with a determination that no two-dimensional code is detected in a camera video frame image of the camera video frame.

17. The device of claim 12, wherein the generating the augmented reality on the device further comprises instructions for:
displaying the augmented reality on the display of the device and in the area occupied by the two-dimensional code in the camera video frame.

18. A non-transitory computer readable storage medium storing one or more programs, the one or more programs comprising instructions, which when executed by an electronic device with a display and a camera, cause the device to:
detect an image capture of a two-dimensional code through a camera video frame;
identify the contour of the two-dimensional code captured in the camera video frame;
decode the information embedded in the detected two-dimensional code;
obtain content information corresponding to the decoded two-dimensional code;
track the identified contour of the two-dimensional code within the camera video frame to obtain the position information of the two-dimensional code in the camera video frame;
perform augmented reality processing on the two-dimensional code based on the content information and the position information; and
generate the augmented reality on the device while simultaneously displaying real-world imagery on the display of the device, wherein any visual augmented reality is displayed in accordance with the location of the two-dimensional code in the video frame.

19. The non-transitory computer readable storage medium of claim 18, wherein the two-dimensional code is a quick-response (QR) code.

20. The non-transitory computer readable storage medium of claim 18, further comprising instructions that cause the device to:
perform down sampling processing against the camera video frame image and attempting to detect the two-dimensional code in the camera video frame image, in accordance with a determination that no two-dimensional code is detected in a camera video frame image of the camera video frame.

21. The non-transitory computer readable storage medium of claim 18, further comprising instructions that cause the device to:
terminate the presentation of the augmented reality on the device, in accordance with a determination that no two-dimensional code is detected in a camera video frame image of the camera video frame.

22. The non-transitory computer readable storage medium of claim 18, wherein the generating the augmented reality on the device further comprises instructions that cause the device to:
display the augmented reality on the display of the device and in the area occupied by the two-dimensional code in the camera video frame.
